(19) United States
(12) Patent Application Publication
(10) Pub. No.: US 2007/0292466 A1
(43) Pub. Date: Dec. 20, 2007

(54) Mold inhibiting mixture and method for application of a mold inhibiting emulsion

(76) Inventor: Stanley Lee Vanek, Nampa, ID (US)

Correspondence Address: HOLLAND LAW OFFICE P.L.L.C., P.O. BOX 1840, BOISE, ID, 83701-1840, US

(21) Appl. No.: 11/471,940

(22) Filed: Jun. 20, 2006

(51) Int. Cl. A01N 65/00; A01N 25/00

(52) U.S. Cl. 424/405; 424/750

(57) ABSTRACT

A mold inhibiting mixture including hydrated lime, (CaH₂O₂), also referred to as calcium hydroxide, mixed with a viscosity enhancing agent, lemongrass oil and an emulsifying agent. In a preferred embodiment, the viscosity enhancing agent includes a base oil. A mold inhibiting emulsion is formulated by mixing water with the mold inhibiting mixture. A method of protecting a building construction material with a mold inhibiting emulsion includes the steps of applying the mold inhibiting emulsion onto at least one surface of the construction material.

### BACKGROUND

The present invention relates to inhibiting mold growth and more particularly the invention is directed to a coating that protects buildings from mold.

The growth of fungi and mold on and in structures has become of major concern to builders, owners and their respective insurers. For instance U.S. Pat. No. 6,894,136 entitled Mold Inhibitor Integrated within a Matrix and Method of Making Same, teaches a composition for the prevention or remediation of mold growth in a man made structures. The composition contains an extruded milo matrix incorporating terpenes, phytoalexins, calcium propionate or combinations of these chemicals having anti-fungal activity. Methods of making and using the described compositions are also disclosed.

While methods have been developed to protect structures from a host of environmental elements and conditions, the successful treatment of structures against the growth of mold has continued to prove troublesome. The solutions proposed to date are costly to implement, often involve the use of toxic chemicals or substances that present additional risks to the environment, the user or both or that require repeated application.

There remains a need for an effective, long term, simple, safe and inexpensive means of inhibiting the growth of fungus and mold on building materials incorporated into structures and in finished building constructions. Therefore, one objective of the present invention is to provide a mold inhibitor that is relatively low in cost to produce and to apply. Another objective of the present invention is to provide a method for applying the mold inhibitor.

### SUMMARY

The present invention is directed to a mold inhibiting mixture including hydrated lime, (CaH₂O₂), also referred to as calcium hydroxide, mixed with a viscosity enhancing agent, lemongrass oil and an emulsifying agent. In a preferred embodiment, the viscosity enhancing agent includes a base oil. In a preferred embodiment, the mold inhibiting mixture also includes a spray tracer. A mold inhibiting emulsion is formulated by mixing water with the mold inhibiting mixture. A method of protecting a building construction material with a mold inhibiting emulsion includes the steps of applying the mold inhibiting emulsion onto at least one surface of the construction material. Preferably, the method includes application of the spraying the mold inhibiting emulsion onto the outer surfaces of all framed component parts of a framed construction and observing that there has been complete coverage as indicated by the spray trace.

These and other features of the invention will be apparent from the following description of the preferred embodiments thereof, and from the claims.

### DETAILED DESCRIPTION

A mold inhibiting mixture according to the present invention includes calcium hydroxide, (CaH₂O₂), (hydrated lime), mixed with a viscosity enhancing agent, lemongrass oil and an emulsifying agent.

In a preferred embodiment of the invention, the viscosity enhancing agent includes a base oil. The base oil may be any of a variety of light mineral or vegetable oils. Horticultural oils are the preferred as they are the least toxic on the market. Horticultural oils are characterized as having a viscosity in the range of approximately 50 to 200. In one preferred embodiment, a paraffin-based horticultural oil is used as the base oil. One such paraffin-based horticultural oil is produced by Bonide Products, Inc., of Oriskany, N.Y. and marketed as Bonide All-Seasons Horticultural Spray Oil or Sunspray Ultra-Fine. In an alternate embodiment, a food-grade canola or cottonseed horticultural oil is employed as the base oil. One such food-grade horticultural oil is marketed as Concern Pesticide Oil, Oil-Away by Gardens Alive, Inc., 5100 Schenley Place, Lawrenceburg, Indiana. Alternately, neem seed-oil extract may be used as the base oil. Neem seed-oil is an extract from the seeds of the neem tree, (Azadirachta indica). In another alternate embodiment, a modified biodegradable petroleum oil may be used as the base oil.

In an alternate embodiment of the invention, the viscosity enhancing agent includes a spreader-sticker agent. A spreader-sticker agent is a biodegradable, combination spreading, sticking and penetrating agent for providing improved distribution and adhesion of the sprayed mold inhibiting emulsion. The spreader-sticker agent is substituted for the base oil and aides the active ingredient chemicals by increasing adhesion to a sprayed surface and providing enhanced flow characteristics allowing the mixture to spread out evenly on the sprayed surface maximizing effectiveness. By providing better distribution and adhesion of the active ingredient chemicals a greater effectiveness is achieved from the mixture reducing waste and cost of application. In one embodiment, the spreader-sticker agent is mixed with ten parts water to make an additive that is then mixed with the hydrated lime, lemongrass oil and the emulsifying agent. In one embodiment a spreader-sticker agent includes ethane, 1,1,1-Trichloroethane, (C₂H₃Cl₃), mixed at a rate of 20-25% with 75-80% phthalic/glycerol alkyl resin. In one embodiment a spreader-sticker agent manufactured by Bonide Products, Inc., of Oriskany, N.Y. and marketed as Turbo spreader-sticker agent is mixed with the active ingredients to provide a mold inhibiting mixture having desirable spreading, sticking and penetrating characteristics.

Lemongrass oil is an extract of one of the grasses of the family Poaceae (Gramineae), species Cymbopogon, i.e., Cymbopogon afronardus, Cymbopogon ambiguus, Cymbopogon citratus, (Andropogon citratus), Cymbopogon citriodora, Cymbopogon flexuosus, Cymbopogon jwarancusa, Cymbopogon jwarancusa, Cymbopogon nardus, Cymbopogon martini, Cymbopogon nardus, Cymbopogon refractus, Cymbopogon schoenanthus, Cymbopogon tortilis, Cymbopogon validus and Cymbopogon winterianus. Lemongrass is a perennial herb widely cultivated in the tropics and subtropics, characterized broadly as East Indian lemongrass and West Indian lemongrass. The qualities of any particular lemongrass oil are determined by the content of citral, terpineol, myrcene, citronellol, methyl heptenone, dipentene, geraniol, limonene, nerol, and farnesol. West Indian lemongrass oil is characterized by a slightly lower citral content than East Indian lemongrass oil.

In a preferred embodiment, the mold inhibiting mixture also includes an emulsifying agent. In the preferred embodiment of the invention, the emulsifying agent is formulated as a 9-Octadecanoic acid (9z)-, monoester with 1, 2, 3 propanetriol. In an alternate preferred embodiment, the emulsifying agent comprises glyceryl monooleate, (C₂₁H₄₀O₄).

In a preferred embodiment, the mold inhibiting mixture also includes a spray tracer mixed with the emulsifying agent so that those areas to which the mixture or an emulsion containing the mixture have been applied are readily discernable from those areas that have not been treated.

A mold inhibiting mixture according to the preferred embodiment of the invention includes hydrated lime, lemongrass oil, a base oil and a spray tracing agent mixed with an emulsifier as follows: Approximately 90.7 kilograms, (two-hundred pounds) of hydrated lime, (CaH₂O₂), 17.24 kilograms, (thirty-eight pounds), of horticultural base oil, 0.45 kilograms, (one pound), of lemon grass oil are mixed with 0.68 kilograms, (one and half pounds), of an emulsifying agent.

In a preferred embodiment, a mold inhibiting emulsion includes a mold inhibiting mixture of hydrated lime, a base oil, lemongrass oil and an emulsifying agent mixed with water at a rate in the range of 2%-50% of the mold inhibiting mixture and 50-98% water. More preferably, a mold inhibiting emulsion includes the mold inhibiting mixture of hydrated lime, lemongrass oil, a horticultural base oil and an emulsifying agent mixed with water at a rate in the range 2%-50% of the mold inhibiting mixture and 50-98% water.

### EXAMPLES

The test procedure for testing resistance to growth of fungi on a treated surface included the inoculating a malt extract agar applied to plates treated with the mold inhibiting emulsion of the present invention. Various mold inhibiting emulsions were formulated and tested. The various mold inhibiting emulsions were prepared by mixing a mold inhibiting mixture according to the preferred embodiment of the invention with water at various concentrations. Two certified strains of fungi, Aspergillus niger and Stachybotrys chartarum, were employed in the testing. The treated and inoculated plates were incubated at 25° C. for a period of 7 days. Colony size as measured by diameter was recorded at the end of the incubation period and compared with the colony size of the same organisms cultured on untreated plates.

According to the test procedure, a mold inhibiting mixture according to the present invention including hydrated lime, lemongrass oil, base oil, emulsifying agent and spray tracer agent was mixed initially. For the purpose of these tests, the mold inhibiting mixture included the following constituents by percentage weight:

Composition—Mold Inhibiting Mixture, (by weight):

| | |
|---|---|
| Hydrated Lime | 82.8% |
| Base Oil | 15.8% |
| Emulsifying Agent | 0.6% |
| Lemongrass oil | 0.4% |
| Spray Tracer Agent | 0.4% |
| Total | 100.0% |

TESTED FORMULATIONS: According to the test procedure, a mold inhibiting emulsion according to the present invention was prepared by mixing the mold inhibiting mixture with water to the percent by volume concentrations shown below.

TABLE 1

| Mold Inhibiting Emulsion: | Sample # 1 | Sample # 2 | Sample # 3 |
|---|---|---|---|
| Mold Inhibiting Mixture | 5.0% | 10.0% | 25.0% |
| Water | 95.0% | 90.0% | 75.0% |
| Total | 100.0% | 100.0% | 100.0% |

According to a preferred embodiment of the invention, a mold inhibiting emulsion is formulated by combining the mixture according to the present invention including hydrated lime, lemongrass oil, base oil, emulsifying agent and spray tracer agent with water. For the purpose of these tests, the mold inhibiting mixture included the following constituents by percentage weight:

TABLE 2

| Mold Inhibiting Emulsion: | Sample # 1 | Sample # 2 | Sample # 3 |
|---|---|---|---|
| Hydrated Lime | 4.14% | 8.28% | 20.70% |
| Lemongrass oil | 0.02% | 0.04% | 0.10% |
| Base Oil | 0.79% | 1.58% | 3.95% |
| Emulsifying Agent | 0.03% | 0.06% | 0.15% |
| Spray Tracer Agent | 0.02% | 0.04% | 0.10% |
| Water | 95.00% | 90.00% | 75.00% |
| Total | 100.00% | 100.00% | 100.00% |

Test results.

TABLE 3

| Test # 1 | Colony size/mm |
|---|---|
| Negative control 1 | No Growth |
| Negative control 2 | No Growth |
| Positive control Aspergillus niger 1 | 95 |
| Positive control Aspergillus niger 2 | 95 |
| Positive control Stachybotrys chartarum 1 | 10 |
| Positive control Stachybotrys chartarum 2 | 12 |
| Sample # 1 Aspergillus niger 1 | No growth |
| Sample # 1 Stachybotrys chartarum 1 | No growth |
| Sample # 1 Aspergillus niger 2 | No growth |
| Sample # 1 Stachybotrys chartarum 2 | No growth |
| Sample # 2 Aspergillus niger1 | No growth |
| Sample # 2 Stachybotrys chartarum 1 | No growth |
| Sample # 2 Aspergillus niger 2 | No growth |
| Sample # 2 Stachybotrys chartarum 2 | No growth |
| Sample # 3 Aspergillus niger 1 | No growth |
| Sample # 3 Stachybotrys chartarum 1 | No growth |
| Sample # 3 duct Aspergillus niger 2 | No growth |
| Sample # 3 Stachybotrys chartarum 2 | No growth |

TABLE 4

| Test # 2 | Colony size/mm |
|---|---|
| Negative control 1 | No Growth |
| Negative control 2 | No Growth |
| Positive control Aspergillus niger 1 | 100 |
| Positive control Aspergillus niger 2 | 95 |
| Positive control Stachybotrys chartarum 1 | 13 |
| Positive control Stachybotrys chartarum 2 | 13 |
| Sample # 1 Aspergillus niger 1 | No growth |
| Sample # 1 Stachybotrys chartarum 1 | No growth |
| Sample # 1 Aspergillus niger 2 | No growth |
| Sample # 1 Stachybotrys chartarum 2 | No growth |
| Sample # 2 Aspergillus niger 1 | No growth |
| Sample # 2 Stachybotrys chartarum 1 | No growth |
| Sample # 2 Aspergillus niger 2 | No growth |
| Sample # 2 Stachybotrys chartarum 2 | No growth |
| Sample # 3 Aspergillus niger 1 | No growth |
| Sample # 3 Stachybotrys chartarum 1 | No growth |
| Sample # 3 duct Aspergillus niger 2 | No growth |
| Sample # 3 Stachybotrys chartarum 2 | No growth |

In the preferred embodiment of the invention, the base oil, the emulsifying agent, the lemongrass oil and spray tracer agent are shipped as a “concentrate.” In this case, a typical formulation for a mold inhibiting concentrate would be formulated to include a viscosity enhancing agent mixed at a concentration in the range of 80% -95%, an emulsifying agent mixed at a concentration in the range of 1.0%-10.0% and lemongrass oil mixed at a concentration in the range of 1.0%-10.0%. A spray tracer agent may also be included in the mold inhibiting concentrate mixed at a concentration in the range of 1.0%-10.0% In a preferred embodiment, a mold inhibiting concentrate is formulated as follows:

Composition—Mold Inhibiting Concentrate, (by weight):

| | |
|---|---|
| Base Oil | 91.9% |
| Emulsifying Agent | 3.5% |
| Lemongrass oil | 2.3% |
| Spray Tracer Agent | 2.3% |
| Total | 100.0% |

A mold inhibiting concentrate is mixed first with hydrated lime to prepare the mold inhibiting mixture described herein above. This mixing is typically performed at the location of application for reasons associated with ease of shipping and handling. Water is then added to the mold inhibiting mixture in the concentrations noted herein above to prepare the mold inhibiting emulsion. The mold inhibiting emulsion is then applied according to the methods of the present invention.

It will be evident that there are additional embodiments and applications that are not disclosed in the detailed description but which clearly fall within the scope of the present invention. The specification is, therefore, intended not to be limiting, and the scope of the invention is to be limited only by the following claims.

I claim:

1. A mold inhibiting mixture comprising:
a viscosity enhancing agent;
an emulsifying agent mixed with the viscosity enhancing agent;
calcium hydroxide mixed with the viscosity enhancing agent; and
lemongrass oil mixed with the viscosity enhancing agent.

2. The mold inhibiting mixture of claim 1 wherein the viscosity enhancing agent further comprises a base oil selected from the group of base oils including a light mineral oils, vegetable oils, horticultural oils, paraffin-based horticultural oils, food-grade canola oil, cottonseed horticultural oil, food-grade canola oil and neem seed oil.

3. The mold inhibiting mixture of claim 1 wherein the viscosity enhancing agent further comprises a spreader-sticker agent.

4. The mold inhibiting mixture of claim 1 wherein the viscosity enhancing agent further comprises a viscosity in the range of approximately 50 to 200.

5. The mold inhibiting mixture of claim 1 further comprising a spray tracer mixed with the emulsifying agent.

6. The mold inhibiting mixture of claim 1 wherein the emulsifying agent comprises 9-Octadecanoic acid (9z)-, monoester with 1, 2, 3 propanetriol.

7. The mold inhibiting mixture of claim 1 wherein the lemongrass oil comprises an extract of one of a grass selected from the group of grasses including Cymbopogon afronardus, Cymbopogon ambiguus, Cymbopogon citrates, (Andropogon citratus), Cymbopogon citriodora, Cymbopogon flexuosus, Cymbopogon jwarancusa, Cymbopogon jwarancusa, Cymbopogon nardus, Cymbopogon martini, Cymbopogon nardus, Cymbopogon refractus, Cymbopogon schoenanthus, Cymbopogon tortilis, Cymbopogon validus and Cymbopogon winterianus.

8. The mold inhibiting mixture of claim 3 wherein the spreader-sticker agent further comprises ethane, 1,1,1-Trichloroethane and a phthalic/glycerol alkyl resin.

9. The mold inhibiting mixture of claim 1 further comprising:
the viscosity enhancing agent mixed at a rate in the range of 10% to 20% by weight;
the calcium hydroxide mixed at a rate in the range of 70% to 90% by weight;
the emulsifying agent mixed at a rate in the range of 0.20% to 2.50% by weight; and
the lemongrass oil mixed at a rate in the range of 0.10% to 5.0% by weight.

10. The mold inhibiting mixture of claim 2 further comprising:
the base oil mixed at a rate in the range of 10% to 20% by weight;
the calcium hydroxide mixed at a rate in the range of 70% to 90% by weight;
the emulsifying agent mixed at a rate in the range of 0.20% to 2.5% by weight; and
the lemongrass oil mixed at a rate in the range of 0.10% to about 5.0% by weight.

11. The mold inhibiting mixture of claim 5 further comprising:
the viscosity enhancing agent mixed at a rate in the range of 10% to 20% by weight;
the calcium hydroxide mixed at a rate in the range of 70% to 90% by weight;
the emulsifying agent mixed at a rate in the range of 0.20% to 2.5% by weight; and
the lemongrass oil mixed at a rate in the range of 0.10% to about 5.0% by weight.

12. A mold inhibiting emulsion comprising:
a viscosity enhancing agent;
an emulsifying agent mixed with the viscosity enhancing agent;
calcium hydroxide mixed with the viscosity enhancing agent;
lemongrass oil mixed with the viscosity enhancing agent; and
water mixed with the viscosity enhancing agent, the emulsifying agent and the lemongrass oil.

13. The mold inhibiting emulsion of claim 12 wherein the viscosity enhancing agent further comprises a base oil selected from the group of base oils including a light mineral oils, vegetable oils, horticultural oils, paraffin-based horticultural oils, food-grade canola oil, cottonseed horticultural oil, food-grade canola oil and neem seed oil.

14. The mold inhibiting emulsion of claim 12 wherein the viscosity enhancing agent further comprises a spreader-sticker agent.

15. The mold inhibiting emulsion of claim 12 wherein the viscosity enhancing agent further comprises a viscosity in the range of approximately 50 to 200.

16. The mold inhibiting emulsion of claim 12 further comprising a spray tracer mixed with the emulsifying agent.

17. The mold inhibiting emulsion of claim 12 wherein the lemongrass oil comprises an extract of one of a grass selected from the group of grasses including Cymbopogon afronardus, Cymbopogon ambiguus, Cymbopogon citrates, (Andropogon citratus), Cymbopogon citriodora, Cymbopogon flexuosus, Cymbopogon jwarancusa, Cymbopogon jwarancusa, Cymbopogon nardus, Cymbopogon martini, Cymbopogon nardus, Cymbopogon refractus, Cymbopogon schoenanthus, Cymbopogon tortilis, Cymbopogon validus and Cymbopogon winterianus.

18. The mold inhibiting emulsion of claim 12 further comprising:
the viscosity enhancing agent mixed at a rate in the range of 0.8% to 3.9% by weight;
the hydrated lime mixed at a rate in the range of 4% to 21% by weight;
the emulsifying agent mixed at a rate in the range of 0.03% to 0.15% by weight;
the lemongrass oil mixed at a rate in the range of 0.02% to 0.10% by weight; and
water mixed at a rate in the range of 75.0% to 95.0% by weight.

19. A mold inhibiting concentrate comprising:
a viscosity enhancing agent mixed at a concentration in the range of 80%-95%;
an emulsifying agent mixed at a concentration in the range of 1.0%-10.0%; and
lemongrass oil mixed at a concentration in the range of 1.0%-10.0%.
